(19) United States
(12) Patent Application Publication
(10) Pub. No.: US 2024/0132209 A1
(43) Pub. Date: Apr. 25, 2024

(54) MULTILAYER DRONE OPERATING SYSTEM

(71) Applicant: Black Sesame Technologies Inc., San Jose, CA (US)

(72) Inventors: Jincheng Wu, Singapore (SG); Tao Xi, Singapore (SG); Zhaonan Li, Singapore (SG); Jin Xu, Singapore (SG)

(21) Appl. No.: 17/972,301

(22) Filed: Oct. 23, 2022

(51) Int. Cl. B64C 39/02

(52) U.S. Cl. CPC B64C 39/024; B64C 2201/141

(57) ABSTRACT

The present invention discloses a multilayer system utilizing a trusted execution environment for creating isolated environments to implement an operating system for commercial drones with increased security. The trusted execution environment creates an isolated environment that runs parallel with the operating system. The utilization of the trusted execution environment as the three-layer system is segmented into three subsystems, wherein each subsystem provides a separate functionality and helps in controlling the flight of the drone.

### FIELD OF THE INVENTION

The scope of the present invention relates to a multilayer operating system for commercial drones that meets an improved standard of security and compactness.

Specifically, the invention discloses hardware solutions for each layer of the operating system, thereby serving layer-specific functionalities in a trusted and secure environment.

### BACKGROUND OF THE INVENTION

With the rapid rise of drone commercialization in recent years, there has also been an increased development in drone operating systems. Generally, these operating systems are not secure and often suffer from compatibility issues due to an effort to cater to future commercialization needs. Normally, there are three parties involved in the drone software development process: drone manufacturers, vendors of autopilot flight solutions, and application developers. Traditional drone manufacturers utilize their own control systems, while autopilot flight solution vendors provide a set of solutions that are sometimes based on specialized processors. These two parties are traditionally not willing to open their source code in an effort to minimize possible security issues and to protect their competitive advantage.

There is related prior art which focuses on control methodologies for controlling the operation of unmanned planes or drones.

Chinese Patent No. 104333733, assigned to Universal Aircraft Technology, discloses a control method of an unmanned plane which utilizes mobile touch gestures to initiate flight directives to control in-flight maneuvers. The control operation is achieved by gathering gesture information that is converted to flight directives that control the plane.

PCT Application No. 2016141100, assigned to Prenav Inc, discloses a method for scanning environments wherein the unmanned aerial vehicle operates. Scanning operations are performed by subroutines present in the controller and produce a computer-based model of the operating environment of the aerial vehicle.

Both these disclosures focus on the control system aspect but lack in a multi-architectural implementation of an autopilot flight solution on a single hardware board by creating a secure trusted environment that runs in parallel with the operating system, thereby increasing operating system security and compactness. The present invention employs the solution of a trusted execution environment (TEE) to a proposed multilayer system as a secure communication method.

U.S. Pat. No. 10,783,251, assigned to Intel Corp., discloses hardware interfaces for drone operation. The disclosed system also includes applications for providing services by the drone. The patent also discloses a drone operating system which is generally utilized for drone management and power control operations. The patent discloses a trusted environment exchange within the drone computing environment but fails to disclose any real time operating system. Further, a multilayer architectural implementation is not disclosed in the patent.

Songran Liu et al. discloses a trust zone assisted TEE for real time systems called MINITEE. MINITEE is a RTOS for managing trusted applications in the secure world.

Songran Liu et al. also presented a case study for a three-degree of freedom control system demonstrating the use case. The system architecture also discloses drivers associated with a trusted execution environment for providing interface for the completion of tasks. However, the architectural description fails to disclose multilayer architectural implementation that utilizes a trusted execution environment for a commercial drone operating system.

Hence, there is a present need for a multilayer architectural implementation that utilizes a trusted execution environment for a commercial drone operating system. There is a need to provide a novel and improved multilayer operating system for commercial drones.

It is apparent now that numerous drone operating systems exist in the prior art that are adequate for various, albeit limited purposes. Even though the prior art may be suitable for the specific purposes to which they address, they are not suitable solutions for the problem that the present invention solves. Thus, there is a need for a drone operating system with improved security and compactness.

### SUMMARY OF THE INVENTION

An objective of the present invention is to provide a multilayer operating system utilizing a trusted execution environment for creating isolated environments to increase commercial drone operating system security. The trusted execution environment creates an isolated environment that runs parallel with the operating system. The utilization of a trusted execution environment as the multilayer system is segmented into three subsystems. The overall architecture is described in detail below.

The first layer system is an open-source operating system, named the Upper-Layer System. It is a normal system that can be a more generic operating system. The Upper-Layer System provides users with a visual interface through which the users can access all non-driving functions. The Upper-Layer System is usually provided by the third-party application developers for use with a variety of drone applications.

The second layer system is a real time operating system (RTOS), named the Middle-Layer System. The Middle-Layer System is a closed-source secure system. The Middle-Layer System integrates the independent autopilot flight solution of the onboard processor manufacturers. This system has core modules for acquiring information related to autopilot flight functions and interface programs for system interactions. The communication between the multiple layers is based, as an example, on the standard ARM TEE protocol, but can also be based on any suitable cross-layer communication protocol

The third layer system is the central control system, named the Control System. The Control System is another secure system. This system is also an RTOS used to control the status of the drone. It is usually developed by drone manufacturers and is the core of the terminal controls. It maintains the entire status of the drone and the status information is transmitted to an upper layer. This communication interaction follows the exemplary ARM TEE protocol.

Each layer of the system runs on an independent processor and each layer can be implemented in isolation with trusted hardware modules. The modules can function in an integrated hardware module as well as in separate hardware modules, such that the crash of an upper-layer (the first layer) of the system will not affect the lower-layer (the third layer). Such a configuration provides protection from hacker attacks.

Each hardware module at each layer has different functionalities. For example, the Upper-Layer System hardware is utilized for interfacing and entertainment related functions. This can be achieved by general purpose processors. The open-source operating module, the closed-source operating modules, and the controlling module all run on general-purpose operating systems, which are utilized by third party application developers on a variety of drone applications. The applications can include abnormality detection features, such as fire detection.

The Middle-Layer System hardware modules generally utilize application specific integrated circuits (ASICs) which can be designed for specific applications, such as autopilot flight control. Such hardware modules can deploy closed-source operating system. Such hardware modules communicate with and help to operate the control system. This processor level communication can typically be achieved through a peripheral communication bus. The secure communication of a three-layer system is achieved through a printed circuit board (PCB) and an authorization certificate that is verified before communication.

The primary advantage of a multilayer system is that the entities involved in the drone development process can maintain focus on their system-specific requirements. For example, drone manufacturers only need to implement a safe control system, while an autopilot flight solution is handled by the solution providers. The Fire Detection Application runs on an open-source system for which developers can find various, suitable abnormality-detection applications. This design reduces development risks and costs while also shortening development time.

Further objectives and aspects of the invention will become apparent from the following detailed description in conjunction with the accompanying drawings, which illustrate the features in accordance with exemplary embodiments of the invention.

To the accomplishment of the above and related objects, the invention may be embodied in the form illustrated in the accompanying drawings. Attention is called to the fact that the drawings are merely illustrative, and that changes may be made to the specific construction illustrated and described remain within the scope of the claims.

Although the invention is described throughout in terms of various exemplary embodiments and implementations, it should be well understood that the various features, aspects, and functionalities described in one or more of the individual embodiments are not limited in their applicability to the embodiment with which they are described. Instead, the invention can be applied, alone or in various combinations, to one or more of the other embodiments, whether such embodiments are described and whether such features are explicitly presented or not. Thus, the breadth and scope of the present invention should not be limited by any of the above-described exemplary embodiments.

The presence of broadening words and phrases such as “one or more,” “at least,” “but not limited to” or other similar phrases in some instances shall not be read to mean that the narrower case is intended or required in instances where such broadening phrases may be absent.

### BRIEF DESCRIPTION OF THE DRAWINGS

The scope of the present invention will become more apparent from the following description and appended claims, taken in conjunction with the accompanying drawings. These drawings depict only typical embodiments of the invention and are, therefore, not to be considered limiting in scope. The invention will be described and explained with additional specificity and detail by the accompanying drawings.

FIG. 1A illustrates a multilayer drone operating system in accordance with the present invention;

FIG. 1B illustrates a schematic representation of the multilayer drone operating system in accordance with the present invention;

FIG. 1C illustrates system architecture of the multilayer drone operating system in accordance with the present invention;

FIG. 2 illustrates a block diagram of ArduPilot as an exemplary auto pilot flight solution in accordance with the present invention; and

FIG. 3 illustrates a method for controlling a flight of the drone in accordance with the present invention.

### DETAILED DESCRIPTION OF THE INVENTION

The present invention discloses the implementation of a three-layer system and an autopilot flight solution on one hardware board, to solve many of the existing problems in the prior art. The invention takes into account the concerns of the three development parties and provides a solution for multiple systems to securely work together. The solution is inspired by the concept of a Trusted Execution Environment (TEE).

TEE is a standard that creates for a main processor an isolated environment that runs in parallel with the operating system running on the main processor. In other words, a Trusted Execution Environment provides a secure area that guarantees code and data loaded inside to be protected with respect to confidentiality and integrity.

Moreover, the way to implement a TEE depends on the processors utilized. For example, in ARM architecture processors, it is the ARM TrustZone technology, and in AMD processors, it is the AMD secure technology. In the current invention, we integrate the solution of a TEE to the proposed three-layer system as a secure way for communication among the subsystems.

The design of the three-layer system ensures that the overall drone operating system enjoys increased security. Further, data is isolated in all subsystems with each subsystem acquiring and storing data independently. This design isolates and, thus protects, the drone manufacturers and the autopilot flight solution vendors from each other.

Due to the modularization and standardization of systems at all layers, they can be replaced with relatively low cost. Drone manufacturers can find multiple adaptable vendors of autopilot flight solutions. Similarly, the vendors of commercial drone operating solutions can easily implement the program to different drone manufacturers. Since the Upper-Layer System, i.e., the first layer, is an open-source system, it can attract many developers. Open-source systems presently have rich applications which can be deployed directly with minimum efforts.

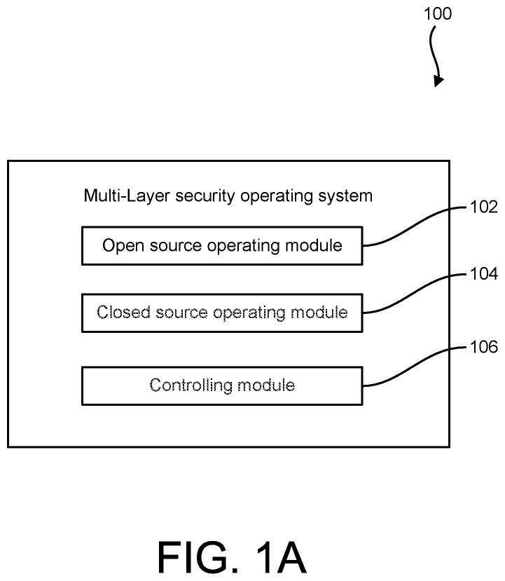

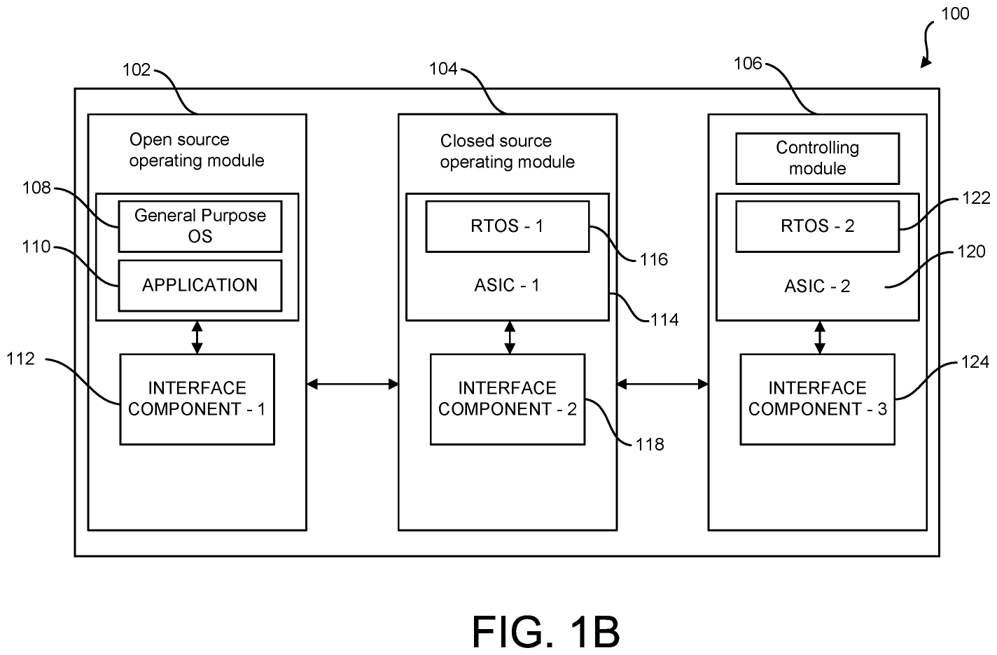

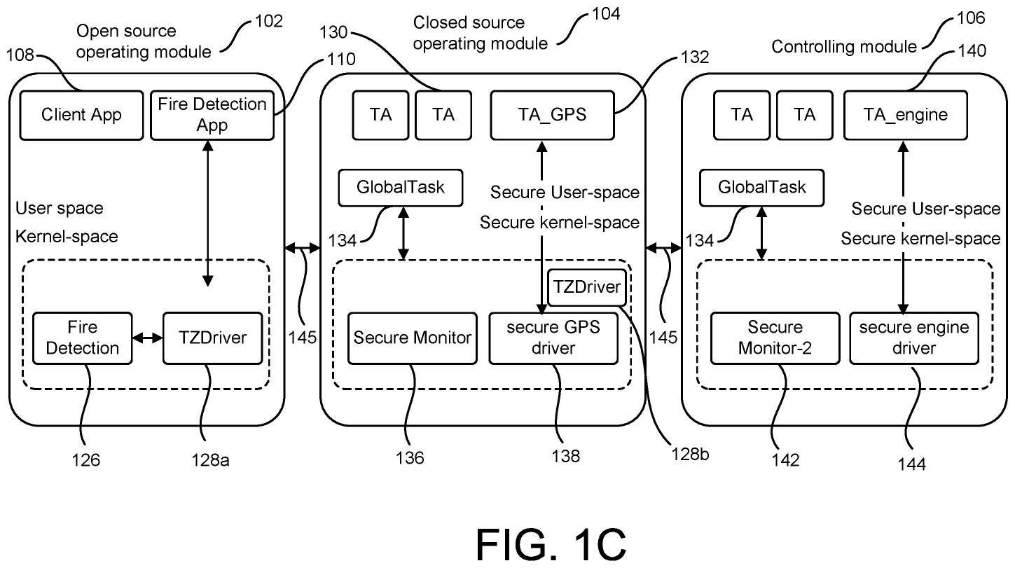

FIG. 1A illustrates a multilayer, secure drone operating system. The multilayer system 100 is a system segmented into three subsystems: an open-source operating module or first layer 102, a closed-source operating module or second layer 104, and a controlling module or third layer 106. The first open-source operating module 102 includes an open-source operating system. Further, the open-source operating module provides visual interface through which users can access all non-driving functions, such as a surveillance function. The surveillance function includes abnormality detection, fire detection, hazard detection, aerial surveillance, survey disaster areas, and/or performing light shows.

The closed-source operating module 104 includes a closed-source operating system. Further, the closed-source operating module 104 communicates with the open-source operating module 102 to provide flight-based functions.

The controlling module 106 receives drone status information from a plurality of sensors. The sensors are positioned either directly on the drone or indirectly through external accessories. The external accessories are equipment required for mounting sensors on the drone. An example of the external accessories is a 3-D mapping device. The controlling module 106 maintains drone status information that is transmitted to the second layer 104. Thus, flight is controlled through the drone status information provided by the controlling module 106.

The first layer 102, named as the Upper-Layer System, includes an open-source operating system. It can be any kind of open-source operating system that provides users with a visual interface through which the users can access all non-driving functions. The open-source operating system allows third-party application developers the freedom to develop a variety of in-drone applications. As shown in the FIG. IC, the Fire Detection App 110 is a fire detection application that runs on the open-source operating system. Fire Detection is a core algorithmic module that receives sensor data from the other layer systems through Trust ZoneDriver (TZ Driver).

The second layer 104, named the Middle-Layer System, is a Real-Time Operating System (RTOS). It is a closed-source secure system. This subsystem integrates the independent autopilot flight solution of the onboard processor manufacturer. This system acquires and saves the original sensor data. As shown in the FIG. 1C, Secure OPS Driver 138 is a core module dealing with location data required for autopilot flight. Autopilot flight modules run in the second-layer system and facilitate the operation of the third layer 106. As shown in the FIG. 1C, the TZ Driver modules (128a, 128b) and the Secure Monitor modules (136, 142) in subsystems 102, 104, and 106 are layer-interfacing programs facilitating subsystem interaction.

A TZ Driver sends request data to a Secure Monitor module of another subsystem, e.g., from subsystem 102 to subsystem 104 or from subsystem 104 to subsystem 106. In general, a Secure Monitor module is in a request-waiting state. When receiving a request from a TZ Driver, the Secure Monitor verifies if it is from a validated user. If the user is validated, the Secure Monitor will call relevant programs running in its own subsystem to process the request operation. The communication protocol between TZ Drivers and the Secure Monitors can be implemented, for example, by deploying the ARM TEE standard protocol. In FIG. 1C, one or more of applications TA 130 run in the closed-source operating system in subsystem 104. For example, a TA 130 can be an autopilot flight algorithmic program.

The third layer 106 is the control layer, as shown in the FIG. 1C. It is another secure system, also including an RTOS, and is used to control the drone status. It is usually developed by a drone manufacturer and is the core terminal control module that maintains the entire status of the drone. Information about the status of the drone will be transmitted to the Middle-Layer 104.

There is significant hardware isolation and system isolation within the three-layer system. On the one hand, this design ensures that a crash in an upper-layer system will not affect any lower-layer systems. On the other hand, it enhances the security and reduces the chance of concurrent multilayer failure.

Each layer of the system runs on one or a group of independent processors. Firstly, as the Upper-Layer System is used for user interface operations and/or entertainment-related functions, general-purpose processors are sufficient. Secondly, Application Specific Integrated Circuits (ASICs) designed specifically for autopilot flight algorithms can be deployed to reduce the algorithms' processing time, which is important to an autopilot flight solution and three processor-level communications. The systems are installed in different processors and communicate through the peripheral communication bus. The peripheral communication bus is illustrated in FIG. 1C by the double-sided arrow between 102, 104, and 106. The inter-layer communication within a three-layer system is through a PCB, and proper authorization certificates are verified before communication to ensure security.

In the invention, a drone is designed according to the disclosed three-layer system, and manufacturers only need to implement a safe third layer. The autopilot flight solution is handled by the solution providers. The Fire Detection application runs in an open-source system for which developers can find several open-source abnormality-detection applications. This design reduces development risks and costs and shortens development time.

FIG. 1B illustrates a detailed system diagram of the disclosed multilayer, secure drone operating system. The system is comprised of individual subsystems at each layer. The multiple layers can be categorized into three subsystem layers, each having their respective hardware and software. As shown in FIG. 1B, the first layer, called the Upper Layer System, is an open-source operating module 102 having a general-purpose operating system 108 associated with it.

The general-purpose operating system 108 provides application 110 support o a variety of drone application developers. There can be various applications developed utilizing this layer that include abnormality detection application, such as fire detection, that can use the open-source operating system present in this layer.

Applications are not limited to fire detection, and any application that supports an open-source operating system can be developed and integrated into this layer. This layer provides a visual interface through which users can access all the non-driving functions.

The hardware deployed at this layer can be met by general purpose processor(s) which are connected to interface component-1 112 and can perform entertainment-related functions. As depicted in FIG. 1B, this layer communicates with the middle layer, i.e., the closed-source operating module 104, for getting information required for application function.

The middle layer, the second component of the three-layer architecture, has application specific integrated circuit (ASIC-1) 114 for autopilot flight solutions. This layer utilizes a real time operating system (RTOS-1) 16 which is a closed-source secure system connected to an interface component-2 118.

Autopilot flight modules run in the second-layer 104 system and facilitate the operation of the Control System 106. The second layer 104 and third layer 106 communicate by utilizing the standard ARM TEE protocol. The controlling module 106 includes an RTOS-2 122 running on an ASIC-2 120 system which is utilized to control the status of the drone. This layer utilizes a real time operating system (RTOS-2) 122 which is a closed-source secure system connected to an interface component-3 124. The interface component-3 is the interface component of the third layer 106 and interface component-2 is the interface component of the second layer 104 (FIG. 1B). It is normally developed by drone manufacturers and is the core module for terminal controls. It maintains the entire status of the drone and transmits the drone status to the second layer 104.

FIG. 1C illustrates the system architecture of the multilayer secure operating system. As shown, to get data from another layer, a driver module TZ Driver 128a, also called a TrustZone Driver, is included in the upper layer 102. The TZ Driver 128a is a port interface program which receives the required information from the other layers for proper application function present in the upper layer, such as the fire detection application.

Further, the middle layer 104 has drivers, including its own TZ Driver 128b, for acquiring information related to flight and autopilot functionalities. These drivers include location information drivers, such as TA_GPS 132, and interfacing and communication drivers, such as TZ Driver 128b.

The TZ Driver 128b sends request data to a Secure Monitor 142 of another system. In general, a secure monitor module, as both the Secure Monitor 136 in the middle layer 104 and the Secure Monitor 142 in the lower layer 106, is in a request-waiting state. When receiving a request from TZ Driver 128b, the Secure Monitor 142 first verifies whether it is from a validated user. If the user is validated, the Secure Monitor will call programs running in its subsystem to process the request through the secure engine driver 144.

The communication protocol between a TZD river and a Secure Monitor can be implemented by referring to the standard ARM TEE protocol. Finally, a control system which controls the drone status is implemented in the third layer. The controller is in communication with the second layer to control the drone status. The hardware modules communicate with the control system and help to operate the control system. This processor level communication can be typically achieved through a peripheral communication bus 145.

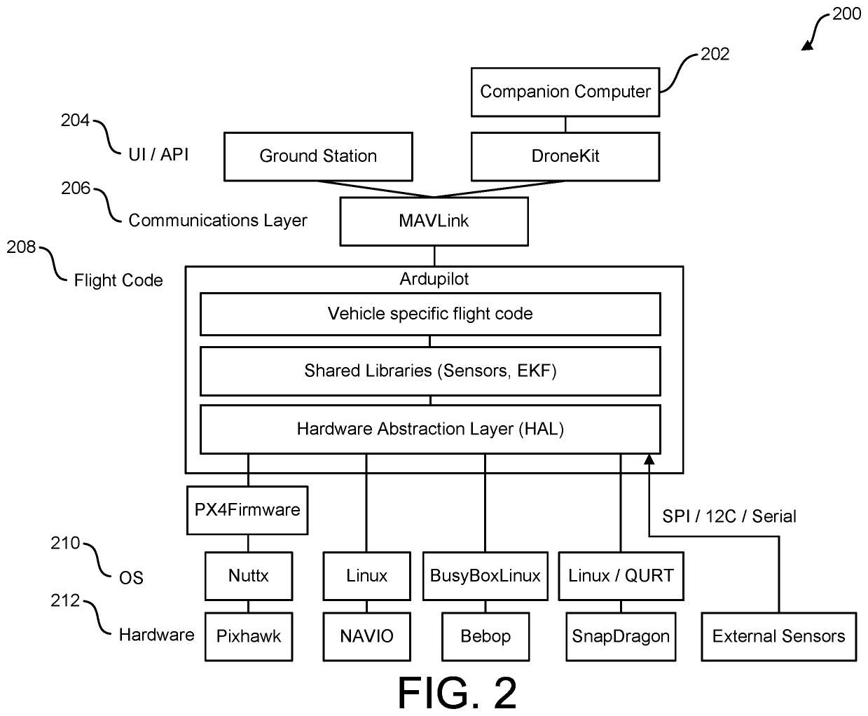

FIG. 2 illustrates a block diagram of the open-source ArduPilot as an exemplary auto pilot flight solution. The ArduPilot architecture 200 is generally utilized as an operating system or control system for commercial drone applications. The architecture can be segregated into five components. More specifically, the basic structure of ArduPilot is broken up into five main parts: Vehicle Code, Shared Libraries. Hardware Abstraction Layer (AP_HAL), Tools Directories, and External Support Code (i.e., maylink, dronekit).

Vehicle Code: The vehicle directories are the top-level directories that define the firmware for each vehicle type. Currently there are six vehicle types: Plane, Copter, Rover, Sub, Blimp, and Antenna Tracker.

Shared Libraries: The libraries are shared amongst all vehicle types. These libraries include sensor drivers, attitude and position estimation (aka EKF), and control code (i.e., PID controllers).

Hardware Abstraction Layer: The AP_HAL layer is key to making ArduPilot compatible with different platforms. There is a top-level AP_HAL in libraries/AP_HAL that defines the interface that the rest of the code has to specific board features. Then, there is an AP_HAL_XXX subdirectory for each board type, for example AP_HAL_AVR for AVR based boards, AP_HAL_PX4 for Pixhawk boards, and AP_HAL_Linux for Linux based boards. The Vehicle Code, Share Libraries, and Hardware Abstraction Layer are a part of Flight Code 208.

Tools Directories: The tool directories are miscellaneous support directories. For example, tools or auto-test provides the auto-test infrastructure behind the autotest.ardupilot.org site and tools or replay provides log replay utility.

External support code: On some platforms we need external support code to provide additional features or board support. Currently the external trees are: PX4NuttX—the core NuttX RTOS is an operating system 210 used on Pixhawk boards 212.PX4Firmware—the base PX4 middleware and drivers used on Pixhawk boards, uavcan—the uavcan CANBUS implementation used in ArduPilot. mavlink—the MAVLink protocol and code generator.

Due to the strict requirements of drones for safety and real-time corresponding, the basic system cannot load too many tasks. So, a companion computer is designed to resolve this problem. As shown at the top of FIG. 2, a companion computer is used to interface and communicate with ArduPilot using the MAVLink protocol a communication layer 206. This companion computer 202 gets all MAVLink data produced by the autopilot and can use it to make intelligent decisions during flight.

Because the companion computer 202 is utilized in the architecture there becomes a requirement of an external board which is connected to the motherboard which causes compatibility problems between different companion computers and hosts, and this greatly affects the performance of the host.

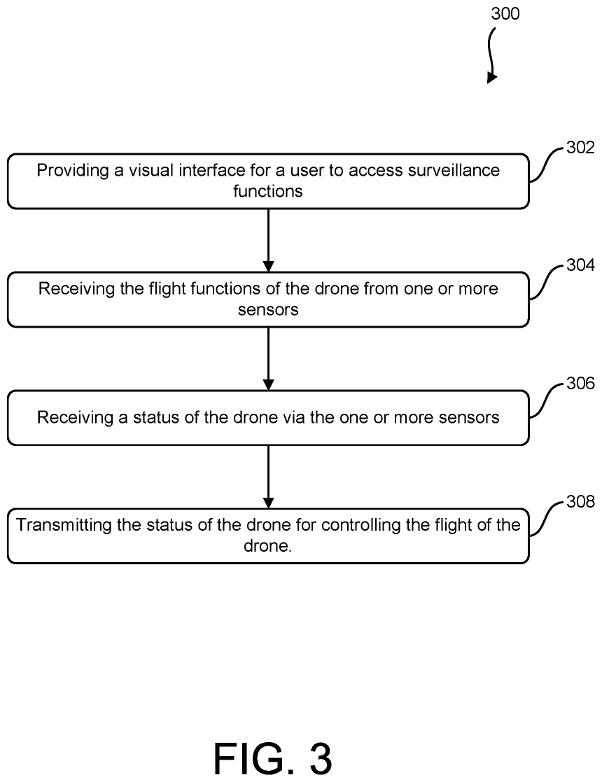

FIG. 3 illustrates a method for controlling the flight of a drone. The method 300 includes firstly providing a visual interface for a user to access surveillance functions 302. An open-source operating module or an upper layer provides a visual interface for a user to access surveillance functions.

Then, secondly, several Right functions are received from one or more sensors 304. The one or more sensors provide information to a closed-source operating module. The closed-source operating module or the middle layer receives the flight functions of the drone from one or more sensors.

Thirdly, a status of the drone is received via the one or more sensors 306 and finally the status of the drone is transmitted for controlling the flight of the drone 308. Thus, once the controlling module receives a status of the drone via the one or more sensors and transmits the status to the closed-source operating module for controlling the flight of the drone. The status of the drone can include state control, path control, landing control, take-off control, and/or elevation control.

While, the various embodiments of the present invention have been described above, it should be understood that they have been presented by way of example only, and not of limitation. Likewise, the figure may depict an example architectural or other configuration for the invention, which is done to aid in understanding the features and functionality that can be included in the invention. The invention is not restricted to the illustrated example architectures or configurations, but the desired features can be implemented using a variety of alternative architecture and configurations.

Although, the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

The presence of broadening words and phrases such as “one or more,” “at least,” “but not limited to” or other like phrases in some instances shall not be read to mean that the narrower case is intended or required in instances where such broadening phrases may be absent.

1. A multilayer operating system for controlling a flight of a drone, comprising:
a closed-source operating module, wherein the closed-source operating module receives flight-based functions of the drone from one or more sensors, and
a controlling module, wherein the controlling module receives a status of the drone via the one or more sensors and transmits the status to the closed-source operating module for controlling the flight of the drone.

2. The multilayer operating system of claim 1, wherein the status of the drone is based on one or more auto-pilot flight algorithms.

3. The multilayer operating system of claim 1, wherein the flight-based functions include an autopilot function and a user operated function.

4. The multilayer operating system of claim 1, wherein the closed-source operating module includes a TZ driver.

5. The multilayer operating system of claim 1, wherein the controlling module includes a secure monitor.

6. The multilayer operating system of claim 5, wherein the secure monitor exchanges the status of the drone with the TZ driver.

7. The multilayer operating system of claim 1, wherein the closed-source operating module and the controlling module are a real-time operating system (RTOS).

8. The multilayer operating system of claim 7, wherein the RTOS provides the flight functions.

9. The multilayer operating system of claim 8, wherein the RTOS within the controlling module provides the status of the drone to the closed-source operating module.

10. The multilayer operating system of claim 8, wherein the flight functions include at least one of autopilot solutions or navigation solutions.

11. The multilayer operating system of claim 1, wherein the status of the drone includes at least one of state control, path control, landing control, take-off control, or elevation control.

12. A multilayer operating system for controlling a flight of a drone, comprising:
a closed-source operating module, wherein the closed-source operating module includes one or more drivers for receiving flight functions of the drone from one or more sensors; and
a controlling module with a secure monitor, wherein the controlling module receives a status of the drone via the one or more sensors and transmits the status to and through the secure monitor for controlling the flight of the drone.

13. A method for controlling a flight of a drone, wherein the method comprising:
providing a visual interface for a user to access surveillance functions;
receiving flight functions of the drone from one or more sensors;
receiving a status of the drone via the one or more sensors; and
transmitting the status of the drone for controlling the flight of the drone.
